(19) United States
(12) Patent Application Publication
(10) Pub. No.: US 2024/0319028 A1
(43) Pub. Date: Sep. 26, 2024

(54) Method for Ascertaining a Force and/or Torque acting on a Component, Sensor Arrangement, and Use thereof

(71) Applicant: Omnitron Peter Zankl, Biel (CH)

(72) Inventor: Peter ZANKL, Biel (CH)

(21) Appl. No.: 18/574,464

(22) PCT Filed: Jul. 12, 2021
(86) PCT No.: PCT/EP2021/069331

§ 371 Date: Dec. 27, 2023

(51) Int. Cl. G01L 3/04

(52) U.S. Cl. CPC G01L 3/04

(57) ABSTRACT

Method for ascertaining a force and/or torque acting on a component (100) in a mechanical system by means of a reference element (10) clampable on the component (100) by a first end, the geometry and/or the relative position of which reference element to the component (100) is sensed by a sensor unit (20), and the effective force and/or torque is/are determined using an evaluation.

### TECHNICAL FIELD OF THE INVENTION

The present invention relates to a method for determining a force and/or torque acting on a component in a mechanical system and to a sensor arrangement usable therefor and a use of the sensor arrangement in different applications.

### STATE OF THE ART

Methods for determining force and/or torque acting on a component or respectively a position of the component in a mechanical system are used in many areas and based on very different technologies. For example, the relative position and orientation between a workpiece and a tool in a machining device are determined to enable precise machining, or force and torque are determined in a robot system to improve its functionality. It is known to use sensors in mechanical systems to detect deformations of the loaded component in time.

Known sensors for detecting forces and/or loads acting in a mechanical system as well as elastic deformations differ depending on the type of force and/or load and/or deformation to be determined. Known sensors include linear force sensors, sensors for measuring torques, sensors for measuring the gravitational force of objects, i.e., scales and pressure sensors for determining a force in relation to a defined area. In general, sensors comprise a sensitive area with a sensor system that differs in terms of the technology used and an evaluation unit that converts the measurable quantity into an electrical quantity that can be transmitted to a control system by means of a signal output.

For the detection of a load or force acting on a component of a mechanical system, it is necessary that the sensor is arranged directly in the force flow, and thus the complete force flows through the sensor. Such an arrangement of a sensor designed as a force transducer requires a certain design effort, so that a subsequent installation of the sensor in an existing mechanical system is significantly more difficult, limited or even impossible. For example, no or only very limited force transducers can be arranged on a rope in such a way that the force can be detected in the middle of the rope. Sensor units such as strain gauges can only be attached at accessible points of the object or component to be measured, and this only by means of expert bonding or the like.

In general, sensors designed as force transducers with strain gauges or alternatively piezoelectric elements can be used for force measurement tasks. The electrical properties of these elements change as a result of the force and/or load effect or a generated mechanical deformation, i.e., the electrical resistance or the charge distribution, and these changes can be detected by the sensor and evaluated by an evaluation unit. Furthermore, optical sensors with transmitter and receiver can be used, which detect position displacements and/or deformations of defined surfaces induced by force application. Sensors that derive a mechanical voltage from a detectable mechanical resonance frequency of an element are also already known.

Also known are sensors that use a reference element and detection means to determine a relative position of the reference element in relation to the object under consideration and to derive from this a force and/or load effect on the object.

For example, WO 2017/162634 describes a sensor which has a recess with reference surfaces separated by a defined distance on a supporting element of a trailer coupling in an area of occurring load. The sensor comprises two separate sensor elements that measure the distance between the reference surfaces, which changes when a load is applied. The sensor elements can detect the gap width located between, and deforming under load, capacitively, inductively, optically and/or etc. Here, too, the arrangement of the sensor requires a certain design of the measurement location, which in this case can lead to a weakening of the supporting element due to the recess.

### SUMMARY OF INVENTION

It is the object of the invention to provide a method for determining the load acting on a component, in particular an acting force and/or a torque in a mechanical system, which can be applied universally. The method can also be used if the location of the load or the loaded component itself is not accessible or suitable. Furthermore, it is the object of the present invention to provide a sensor arrangement that can be used universally for determining a load, in particular a force and/or torque, acting on a component of a mechanical system, without it being necessary for the measurement and the arrangement of the sensor arrangement to take place or lie in the force flow of the acting force. In particular, the sensor arrangement can also be attached subsequently to the component or respectively in a mechanical system without the system itself being affected, even if only marginally.

The objects are achieved in particular through the features of a method according to claim 1, a sensor arrangement according to claim 8 and uses of the sensor arrangement according to claims 14 to 18. Advantageous further developments of the invention are described by the dependent claims.

The method according to the invention for ascertaining the force and/or torque acting on a component in a mechanical system uses a reference element which can be clamped or fixed to the component by a first end, the geometry and/or position of which relative to the component is detected by means of a sensor unit which can be arranged on or relative to the component, and the acting force and/or the acting torque can be determined by means of an evaluation.

In an unloaded state or a definable initial state of the component in a mechanical system, for example a shaft, a cable or a rod in a structure, a crossbeam in a supporting structure, a gripper, a tool etc. or also a fluid-carrying pipe or a container, the sensor unit can determine a geometry and/or a relative position of the reference element and define this as a reference value. Under load or when the load on the mechanical system or the component changes, the geometry and/or the relative position of the reference element with respect to the component changes and can be detected by the sensor unit as a measured value. The difference between the reference value and the measured value can be a linear displacement along a longitudinal axis of the component, an inclination against a longitudinal axis of the component and/or a circumferential change or etc., depending on the measuring situation.

Alternatively, a load on a component can also be detected optically by means of a pattern shift. In this case, the component can have a line pattern or raster and the reference element can have a structure in the form of a raster, which, when superimposed, form a defined optical pattern that changes under load. The relative position change of the reference element can be detected optically, e.g., in the form of a moiré effect. An evaluation of the determined difference is based on certain correlations between the difference and the force, load, torque and/or pressure acting on the component.

The method is based on a measurement of an acting force and/or a torque not at the place of the force action, or not in the force flow itself, but at a place arbitrarily selectable within limits, at which the force is noticeable in the mechanical system or at the component also called measuring body. The force effect is detectable and determinable by means of a relative position and/or a geometry. The method can be based on the detection of relative positions and/or deformations or displacements of geometries.

The method is based on an indirect determination of an acting force, load and/or torque by means of a simply detectable effect of the force, load and/or torque. The detectable effect of the force, load and/or torque on the considered component can be easily detected by means of a geometry and/or a relative position, in particular a surface and/or a structure, for example an edge, of the reference element in relation to the considered component or a pattern provided thereon by the sensor unit. The reference element arranged on the component under consideration, which can preferably only be firmly connected to the component on one side, can be regarded as largely unloaded when the component is loaded. Accordingly, the reference element serves as an unloaded reference object for the loaded component. Advantageously, the mechanical system itself is not or only marginally influenced by a sensor arrangement based on the method. In particular, the sensor arrangement is designed in such a way that its mass is low, an electrical contact or an optical contact or a data transmission to an evaluation unit has no influence on the function of the component under consideration, whereby at the same time the load can be clearly determined. Furthermore, it is advantageous that the method can also be used for an already existing mechanical system, which can be retrofitted with a corresponding sensor arrangement.

In one embodiment of the method, the reference element, which is fixable at its first end to the component under consideration, may extend with a free length substantially parallel to the component to a second end. In one embodiment, the second end is a free end and provided with a defined structure, edge and/or surface. The defined edge, surface and/or structure at the second end of the reference element facilitates a position and/or geometry determination by the sensor unit.

For example, the reference element can be designed as a U-shaped profile, whereby a first end can be fixed to the component. The connection can be made by pressing, gluing and/or by means of an auxiliary device, e.g., a clamp or screw connection, so that the first end is fixed to the component and the free length of the reference element extends largely parallel to it.

It is also conceivable that the second end of the reference element rests on a part of a surface of a sensor unit positioned on the component, for example an optical sensor unit. The sensor unit may comprise a commercially available camera image sensor, i.e., CCD or CMOS sensors, with pixel sizes from 1.5 micrometers, which are significant in terms of resolution and thus in terms of a load to be detected. Alternatively, another type of sensor can be used instead of an optical sensor unit, which can then be combined with a reference element matched to it.

In another embodiment, the second end of the reference element is also fixable to the component under consideration, the reference element extending with its free length substantially parallel to the component. Accordingly, in certain mechanical systems, an amplified effect can be detected under load of the component by means of the provided sensor unit. For example, an indicator element can be provided on the reference element, the displacement of which, induced by a relative elongation of the reference element under a changing load on the component, can be detected by means of the sensor unit which can be arranged accordingly.

According to one variant of the method, the detectable geometry and/or the relative position of the reference element determines, on the one hand, a reference value in an unloaded or a basic state, and, on the other hand, a measured value under load or changing load. From the difference between the reference value and the measured value, a change in the force and/or torque acting on the component can be determined. Depending on the case, the difference can be a path length and/or an angle or an optical effect such as a moiré effect.

The evaluation of the determined values is based on a relationship to be defined, and varies depending on the mechanical system and application. For example, there can be a proportional relationship between the determined difference of the relative positions and the acting force, which can be described with a linear function. In the simple case of a linear position change due to an axially acting load on the component considered as measuring body, this is proportional to the acting force, proportional to the free length of the reference element and inversely proportional to a spring constant of the measuring body.

In other cases, the relationship between the relative positions and the force, load and/or torque to be determined may be nonlinear. The evaluation can be based on a mathematical model that describes the acting force and/or torque as a function of the detected values and characteristics of the component.

Alternatively, the evaluation can be based on a previous calibration, which puts the acting force and/or torque and the difference of relative positions and/or geometries into context with each other.

The sensor unit, which can be arranged on the component under consideration in such a position that it detects geometries and/or relative positions, can be designed as an inductive, magnetic, optical, capacitive sensor unit or the like. Depending on the area of application and/or place of use, a suitable sensor unit can be selected which can be fixed directly to the component. It is also conceivable that the sensor unit is not arranged directly on the component under consideration, but can be arranged by means of a connecting means in an area in which the load acting on the component under consideration can be detected at least indirectly. Advantageously, the sensor technology used by the sensor arrangement according to the invention is irrelevant to its mode of operation. Accordingly, a suitable sensor technology can be selected and used depending on the application or place of use.

The method according to the invention can be used universally. With the embodiments of the method, linear, axial forces acting on a component can be determined as well as transverse forces or forces acting at an angle to a longitudinal axis of the component, torques on a component designed as a longitudinal shaft, and pressure forces, for example acting on and/or in a component designed as a tube or container. The method is also universally applicable in the sense that it is used if the component under consideration is difficult or impossible to access and/or if the functionality of the component at the location of the load would be impaired by a placed sensor arrangement.

The present invention also relates to a sensor arrangement based on the method of the invention. The sensor arrangement comprises a reference element having a first end fixed and extending with a free length to a second end, and a sensor unit disposable relative to the reference element on the component so as to be arranged to determine a geometry and/or a relative position and/or structure of the reference element. In one embodiment, the sensor unit may be directly attached to the component. Alternatively, the sensor unit, for example an optical sensor or a camera, can be arranged relative to the component and the second end of the reference element so that a relative displacement between the second end and the component under consideration can be detected. It is conceivable that the second end of the reference element has a structure that corresponds to a pattern or raster or structure provided on the component, so that with a relative change in position an effect is created that can be optically detected by the independently arrangeable sensor unit.

According to one embodiment of the sensor arrangement, the sensor arrangement is attachable to the component of the mechanical system, whereby the reference element is attachable to the component by the first end, the free length extends substantially parallel to a surface of the component, and the sensor unit is attachable to the component or relative to the component to determine the changing geometry and/or relative position of the reference element.

In one embodiment of the sensor arrangement, the reference element is in the form of a rod or a plate with the first end designed fixable to a component of a mechanical system. The reference element can also have another suitable shape, for example a slotted sleeve and be fixed by means of a clamp connection to the component in question. The free length of the reference element can extend from the first fixed end to the second end, largely parallel to the component under consideration. The reference element may also be designed to conform to a surface of the component under consideration.

According to one embodiment, the second end of the reference element can be designed as a free second end and have a defined structure, edge and/or surface, by means of which changes of geometry or shifts of relative positions can be detected. Alternatively, the second end can also be clamped to the component, so that a kind of amplification of the measurement signal can be achieved.

A longitudinal extension of the free length of the reference element, in particular parallel to the component under consideration, can be selected in such a way that a relative movement of the reference element measurable by the sensor unit is generated when force and/or load is applied. For this purpose, the measurement sensitivity of the sensor unit in question must be taken into account. In the case of a component that is acted upon in the longitudinal direction, the free length of the reference element must be selected in such a way that even minimal changes in the component under consideration can be detected by the sensor unit.

In a further embodiment, an edge, surface and/or structure may be provided at least in part on the reference element to assist in determining geometry and/or relative positions.

In one embodiment, the reference element may be made of a material that has a coefficient of thermal expansion equal to that of the component for which the load is verified by the sensor arrangement. Thus, it is possible that the reference element and the loaded component of a mechanical system undergo a comparable deformation and/or elongation due to thermal effects.

According to one embodiment of the sensor arrangement, the sensor unit is designed as an inductive sensor, a magnetic sensor, capacitive sensor or an optical sensor.

Furthermore, the present invention relates to a use of the sensor arrangement. According to one embodiment, the sensor arrangement can be used to determine a linear axial force acting on a linear measuring body. If an axially acting force, or a tensile or compressive force, is applied to the component, the component, referred to as the measuring body, undergoes a change in its length. The reference element connected or clamped to the loaded component with its first end, which extends with its free length approximately parallel to the longitudinal component, does not however experience a change in its length or not to the same extent. The force acting on the component in the longitudinal direction can therefore be determined from the relative positions determined by the sensor unit. In particular, the force to be determined is proportional to the length of the reference element and inversely proportional to a spring constant of the component. From the proportional relationship between the force to be determined and the free length of the reference element, it can be deduced that this value can be adjusted to achieve a higher accuracy of the measurement.

Furthermore, the sensor arrangement is suitable for transverse force measurements on, for example, a beam or girder which rests with its two ends on bearings. When the beam is loaded in a direction perpendicular to its longitudinal axis, the beam will deform to a certain extent, with the longitudinal axis of the beam assuming a curved course under load with a continuously changing inclination to the original position of the longitudinal axis. A sensor arrangement attached to the beam, on the other hand, behaves differently under load. The reference element, which is detachably connected to the beam at the first end, also undergoes a change in position, whereby the longitudinal axis of the reference element includes a constant angle of inclination to the original position of the longitudinal axis, depending on the fastening position. The second free end of the reference element is displaced relative to the component, which is designed as a measuring body. The displacement can be detected by means of the sensor unit, which can be arranged on the component in a determinable position. From the determined displacement, by means of an evaluation algorithm, based on a mathematical model and/or based on a calibration of the system, comprising sensor arrangement and component designed as a measuring body, a relationship between the displacement or the measurement signal generated therefrom of the at least one sensor arrangement to the force and/or load acting on the beam can be concluded.

According to a further application, the sensor arrangement can be used to measure a torque acting on a shaft. For this purpose, the sensor arrangement is arranged on the shaft so that, starting from the first fixable end of the reference element, the latter extends with its free length approximately parallel to the longitudinal axis of the shaft up to its second free end. In case of torsion of the shaft by a torque acting on it, the reference element remains in its elongated form. A change in position of the second free end of the reference element relative to the circumferential surface of the shaft can be detected by means of the sensor unit. The change in position is proportional to the torque acting on the shaft and the measurement signal of the sensor unit can be evaluated accordingly.

Another example of use is the application of the sensor arrangement for determining rope loads, for example for a safety net. Advantageously, the sensor arrangement is designed in such a way that it can be subsequently arranged on a rope, whereby the reference element can be placed on the rope by means of a releasable clamping connection at a first end and the sensor unit by means of a releasably attachable connecting means. The sensor unit can be designed to detect a position of a tab formed on the second end of the reference element, preferably in a non-contact manner.

According to one variant, the sensor arrangement can also be used to measure pressure. In this case, for example, the pressure can be measured on a container or pipe that can be pressurized with fluid, which can deform the component in all three dimensions. Depending on the measuring task of the sensor arrangement, it can, for example, comprise a reference element which is arranged in a tangential direction around the component. Other arrangements and forms of the reference element of the sensor arrangement are also conceivable in order to detect and evaluate the expansion of a pipe pressurized with fluid in all three dimensions.

The sensor arrangement can also be used to determine forces and/or loads at locations that are difficult to access or where the measurement location does not allow the sensor arrangement to be placed without interfering with the function and/or movement of the component or mechanical system under consideration and/or due to an intolerable load on the component under consideration at that location. For example, a conventional sensor cannot be placed in a system comprising a gripper of a robot and an object to be gripped and held by the robot without affecting the operation of the gripper. However, the sensor arrangement according to the invention allows a placement and arrangement outside the force flow. Accordingly, a positioning of the sensor arrangement outside the gripping space, for example at components of the mechanical system following the gripper, can be provided. Also, at this position the forces and the deformations can be detected, which occur during an actuation of the gripper.

Further applications are possible, whereby the sensor arrangement according to the invention is designed and dimensioned according to the measurement task.

### BRIEF DESCRIPTION OF THE DRAWINGS

The invention will be explained more closely with reference to embodiment examples in connection with the drawings.

FIG. 1a shows a schematic perspective view of a sensor arrangement according to a first embodiment;

FIG. 1b shows a schematic lateral view of the sensor arrangement of the first embodiment in a first application;

FIG. 1c shows a schematic lateral view of the sensor arrangement of the first embodiment in a measuring situation;

FIG. 2a shows a schematic lateral view of a sensor arrangement of in a second application;

FIG. 2b: shows a schematic lateral view of the sensor arrangement according to FIG. 2a in a measuring situation;

FIG. 3 show a schematic perspective view of a sensor arrangement according to a second embodiment in an application;

FIG. 4a shows a schematic perspective view of a sensor arrangement according to the first embodiment in a third application;

FIG. 4b shows a schematic detail view of the sensor arrangement according to FIG. 4a;

FIG. 4c shows a schematic detail view of the sensor arrangement according to FIG. 4a in a measuring situation;

FIG. 5a shows a schematic view of a sensor arrangement according to a third embodiment in an application;

FIG. 5b shows a schematic view of a sensor arrangement according to FIG. 5a in a measuring situation;

FIG. 6a shows a schematic perspective view of a sensor arrangement in a measuring situation;

FIG. 6b shows a schematic detail view of the sensor arrangement according to FIG. 6a;

FIG. 7 shows a schematic view of a further embodiment of the sensor arrangement in a starting situation and a measuring situation.

### PREFERRED EMBODIMENTS OF THE INVENTION

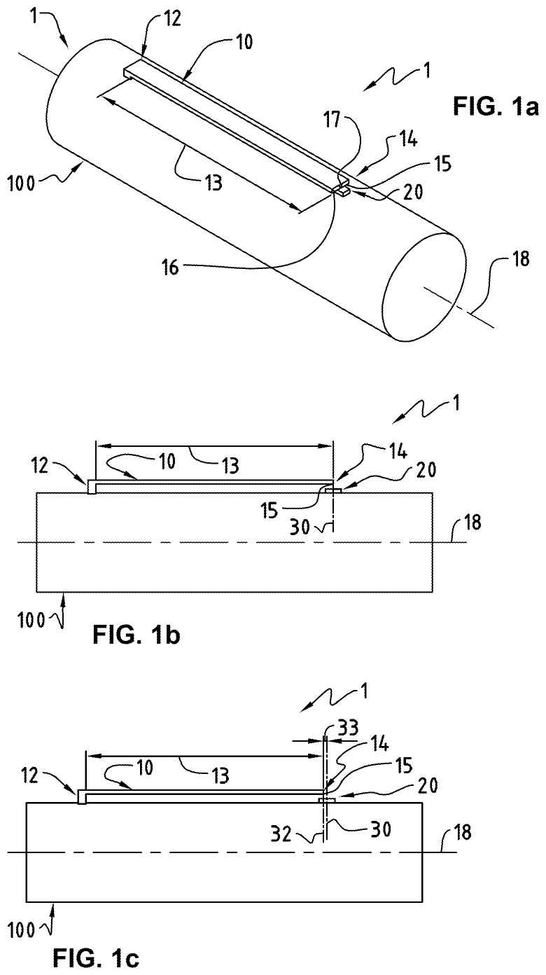

FIG. 1a shows a schematic perspective view of a sensor arrangement 1. The sensor arrangement 1 comprises a reference element 10 and at least one sensor unit 20. The reference element 10 can be designed in a variety of shapes and dimensions. In the illustrated embodiment of the sensor arrangement 1, the reference element 10 is formed as an elongated body, for example as a plate or rod. A first end 12 of the reference element 10 is adapted to be clamped to a component 100 of a mechanical system. In particular, the first end 12 is releasably attached to the component 100 by means of a clamp and/or screw connection and/or non-releasably by means of adhesion, welding. A free length 13 of the reference element 10 extends, starting from the clampable first end 12, to a second end 14, which in the illustrated embodiment is formed as a free second end 14. The second free end 14 of the reference element 10 has an edge 15 which is suitable for defining a definable relative position with respect to the component 100. The edge 15 can also be a surface or an end region 16 however with a scale or structure 17 (shown in FIG. 1b), which is suitable for determining a relative position of this edge 15, or surface 16, in relation to the component 100.

In the embodiment shown, the free length 13 of the reference element 10 runs largely parallel to the component 100 in the direction of a longitudinal axis 18 of the component 100. The distance between the free length 13 of the reference element 10 and a surface of the component 100 should be as small as possible in order to be able to use the sensor arrangement 1 for small installation situations.

The sensor arrangement 1 further comprises the sensor unit 20, which can be arranged relative to the reference element 10, in particular on or in relation to the component 100 referred to as the measuring body. The sensor unit 20 is set up to determine a relative position and/or a geometry of the reference element 10. The sensor unit 20 can be designed as an optical, magnetic, capacitive or inductive sensor unit 20. The sensor unit 20 may be attached to the component 100 relative to the second free end 14 of the reference element 10, for example by adhesion or in another suitable manner.

FIG. 1b shows a side view of the sensor arrangement 1 according to FIG. 1a in an initial situation. Here it can be seen that the reference element 10 extends from its fixable first end 12 with the free length 13 to its second free end 14 largely parallel to the component 100, and at the second free end 14 the edge 15 is defined. The sensor unit 20 arranged at the component 100 is adapted to determine a reference value 30 of the edge 15 and/or a surface 16 and/or structure 17 of the reference element 10.

FIG. 1c shows a measurement situation of the sensor arrangement 1 in relation to the component 100. If the elongated component 100 is axially loaded, i.e., subjected to a tensile or compressive force, the length of the elongated component 100 changes along the longitudinal axis 18. In contrast, the length of the reference element 10 remains largely constant despite the load. The position and/or geometry of the reference element 10, i.e. the second free end 14, or the edge 15, surface 16 and/or structure 17 formed thereon, which can be detected under load, is recorded by the sensor unit 20 as a measured value 32 and set in relation to the reference value 30. From a difference 33, which in this case is a path length, the force acting on the elongated component 100 in axial direction can be determined on the basis of a mathematical function. A displacement can also be ascertained in the form of an angle between longitudinal axes, and, by means of an evaluation, the load forces and/or load torques acting on the component 100 can be determined.

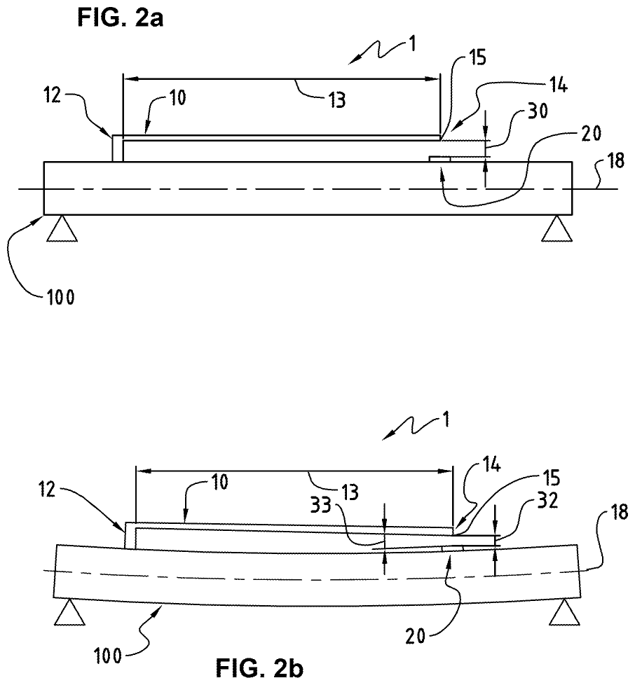

FIG. 2a shows a further application of the sensor arrangement 1 according to the first embodiment. In the embodiment shown, the measuring body is an elongated component 100, for example a carrier in a mechanical system, which is borne in end regions. The reference element 10 of the sensor arrangement 1 is connected with its first end 12 to the component 100, wherein the connection can be a detachable attachment or a welded or adhesive connection or the like. The reference element 10 extends with its free length 13 in the direction of the longitudinal axis 18 and substantially parallel to the surface of the component 100 with a certain distance and ends in the second free end 14. The sensor unit 20 is arranged on the component 100 with reference in the area of the second free end 14, for example by means of adhesion or by means of a connecting means. The second free end 14 can comprise an edge 15, a structure or scaling 17 and/or a surface 16, which can be detected by the sensor unit 20 in order to be able to record values which change when the component 100 is loaded. In an unloaded state or in a definable state of the component 100, a reference value 30 can be detected to which further values to be measured 32 can be referred. In the example shown, the reference value 30 is a distance between the edge 15 and the sensor unit 20, but can also designate another value, e.g., a position.

FIG. 2b shows a measurement situation of component 100 supported on two bearings. This application example is representative for a supported beam or girder in a building structure. Such a beam is subjected to transverse forces, i.e., forces transverse to the longitudinal axis 18 of the elongated component 100. A sensor arrangement 1 able to be disposed on this component 100 comprises the reference element 10, which extends largely parallel to the longitudinal axis 18 and is connected thereto only by means of its first end 12. The loading of the supported component 100 by transverse forces leads increasingly to a deflection of the component 100, whereby the longitudinal axis 18 is at a constantly changing angle relative to its horizontal starting position. The reference element 10 connected to the component 100 at the first end 12, on the other hand, assumes a position under load that can be described by a constant angle of inclination to the horizontal starting position. This relative shift between the reference value 30 detectable by means of the sensor unit 20 arranged on the component 100 and a measured value 32 can be a difference 33 or described in the form of an angle. This angle, also referred to as difference angle 33, can be evaluated by means of a mathematical function to determine the value or values of the prevailing transverse forces.

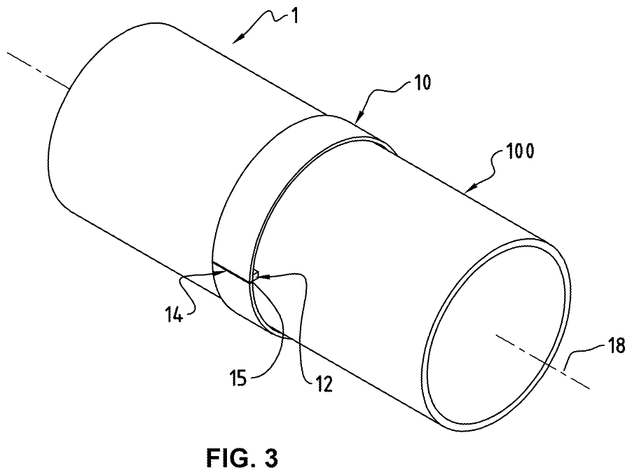

FIG. 3 shows a second embodiment of the sensor arrangement 1 in an application example. Here, the sensor arrangement 1 according to the invention is arranged to detect an internal pressure in a tube which can be pressurized with a fluid, and which represents the component 100 designed as a measuring body. A fluid-carrying pipe expands under pressure in all three dimensions. Accordingly, the reference element 10 of the sensor arrangement 1 can be arranged in the form of an open ring on the circumference of the tube and connected to the first end 12 thereof. The reference element 10, which is formed as an open ring, ends at the second end 14, at which an edge 15 is formed, which is positioned relative to the sensor unit 20 (not shown). When fluid is applied to the tube, an expansion of the tube can occur, which can be detected by means of the arranged sensor arrangement 1. The change of the tube circumference can be set as largely proportional to the pressure. However, other arrangements of the sensor arrangement 1 are also conceivable, which are suitable for detecting a change in the diameter and/or an axial dimension of the tube acted upon by fluid.

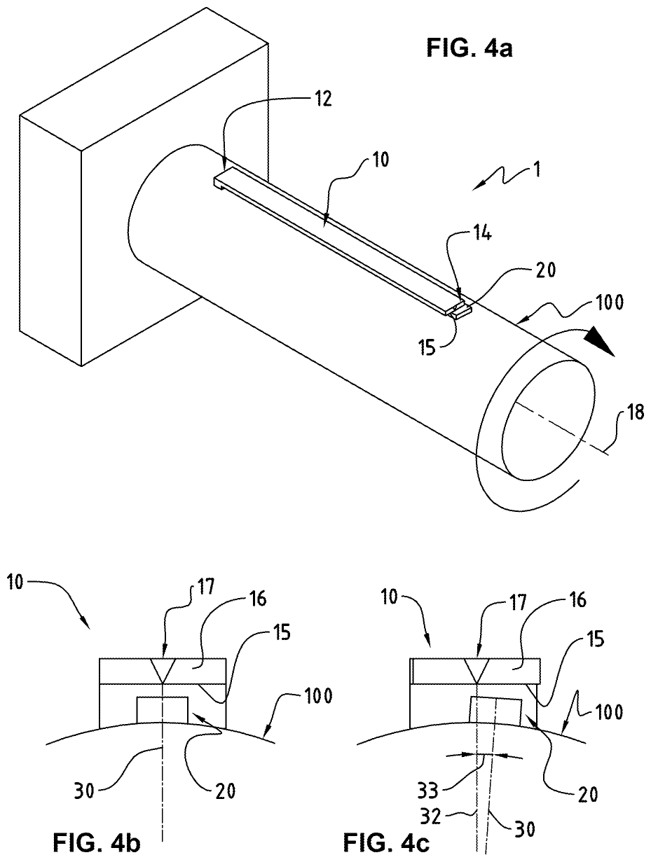

FIG. 4a shows the sensor arrangement 1 according to the first embodiment in a further application example. Here the component 100, which can be designated as the measuring body, is a shaft extending along a longitudinal axis 18, on which torsional forces act. Illustrated is a shaft clamped on one side, but shafts mounted on both sides can also be considered as component 100. In this application example, the reference element 10 clamped on one side at the first end 12 can be regarded as unloaded, whereby the torsional forces and/or torques acting on the component 100 lead to a torsion of the shaft, which can be detected by means of the sensor arrangement 1 at the second end 14 by means of the sensor unit 20.

In FIG. 4b, an unloaded position of the component 100 and the sensor arrangement 10 arranged thereon is shown in a detailed view. The second free end 14 of the reference element 10 with its edge 15 or surface 16 and the structure 17 can be seen. The structure 17 is shown as an arrow, but can have a variety of shapes. Furthermore, the sensor unit 20 is arranged on the component 100 under consideration in a position which is in relation to the second free end 14. In this situation shown in FIG. 4b, the reference value 30 can be determined.

FIG. 4c shows a measurement situation. When the component 100 is loaded, there is a relative change in position of the edge 15, surface 16 and/or structure 17 formed on the reference element 10, which can be detected by the sensor unit 20 positioned at an appropriate location. In the application example shown, a torque acting on the component 100 under consideration causes a torsion, which is identifiable in the form of a differential angle 33 between reference element 10 and component 100, or respectively between reference value 30 and measured value 32. The acting forces and/or torques can be determined by means of a mathematical relationship or by means of a calibration, whereby an evaluation takes place in a suitable unit to which determined measurement data can be transmitted.

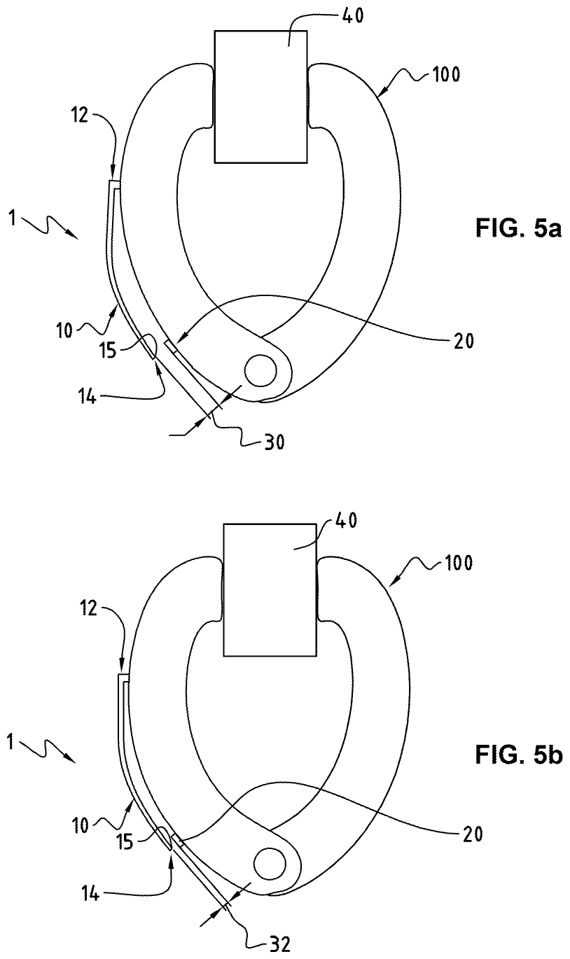

FIG. 5a shows a further embodiment of the sensor arrangement 1, which is arranged on a component 100 designed as a gripper. In this arrangement, the sensor arrangement 1 is not arranged directly in the loaded area, i.e., in the area where the component 100 designed as a gripper is in operative connection with a part 40 to be gripped, but in an area of the component 100 that is at least indirectly influenced by the load. In FIG. 5a, the sensor arrangement 1 is arranged laterally on the gripper component 100, with the sensor unit 20 being detachably or non-detachably attached to it. If the position of the gripper 100 changes, there is a relative displacement between the reference element 10 clamped on one side at the first end 12 and the gripper 100. In other words, the initial position of the component 100 designed as gripper can be identified by means of the reference value 30.

As shown in FIG. 5b, the position of the reference element 10 relative to the gripper 100, that is in a relationship to it, changes so that a measured value 32 can be detected by the sensor unit 20. This measured value 32, set in relation to the reference value 30, can be evaluated. The evaluation can be performed in such a way that a value of the load on the gripper 100 can be generated therefrom.

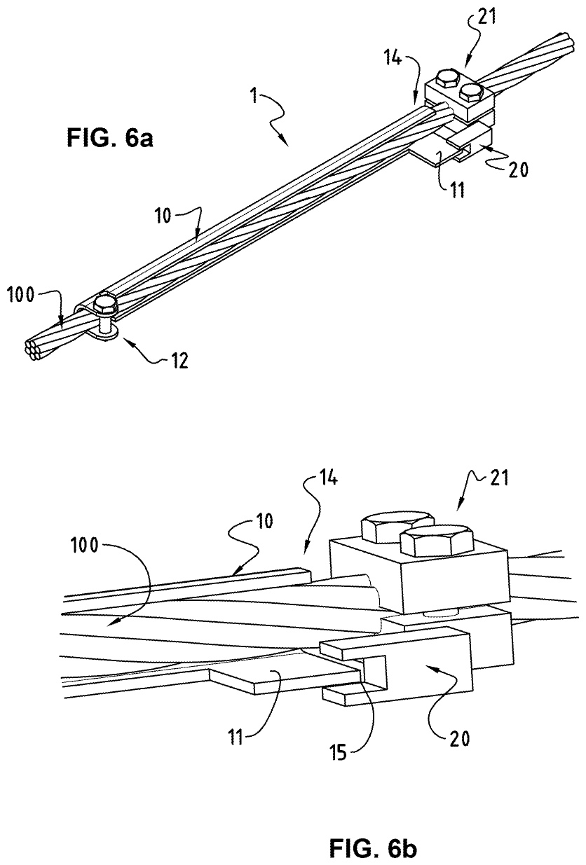

FIG. 6a shows a further example of use of a sensor arrangement 1, where the component 100 is a rope and the reference element 10 is a slotted sleeve extending from the first fixed end 12 to the second end 14 with the free length 13. The fixation of the first end 12 of the reference element 10 is solved by a simple clamp and screw connection in the illustrated embodiment. At the second end 14, a kind of tab 11 with the defined edge 15 is formed, which extends from the reference element 10. The sensor unit 20 is detachably arranged on the component 100 by means of a connecting means 21, so that the tab 11 of the reference element 10 is arranged between the legs of the sensor unit 20 without contact, as shown in FIG. 6b. When the rope-shaped component 100 is loaded, the position of the tab 11 or the edge 15 (not shown) of the reference element 10 between the legs of the sensor unit 20 changes, so that a measurement signal can be detected which, when evaluated, provides information about the load or a change in the load in the form of a change in the length of the rope-shaped component 100.

FIG. 6b shows the sensor arrangement 1 and the sensor unit 20 in detail. The sensor unit 20 is arranged on the component 100 by means of a connecting means 21. The connecting means 21 is designed as a clamping sleeve, which can be arranged by means of screw connections on the component 100, which is designed as a rope. The free end 14 of the reference element 10 comprises the tab 11, which protrudes tangentially and is received between legs of the sensor unit 20 without contact. If the component 100 moves under load, in particular in the longitudinal direction, the position of the tab 11 changes relative to the legs of the sensor unit 20, which can be designed as an optical sensor, for example. By means of a changing overlap between a light source and a receiver, arranged in the opposite legs of the sensor unit 20, conclusions can be drawn about the load acting in the rope in the axial direction.

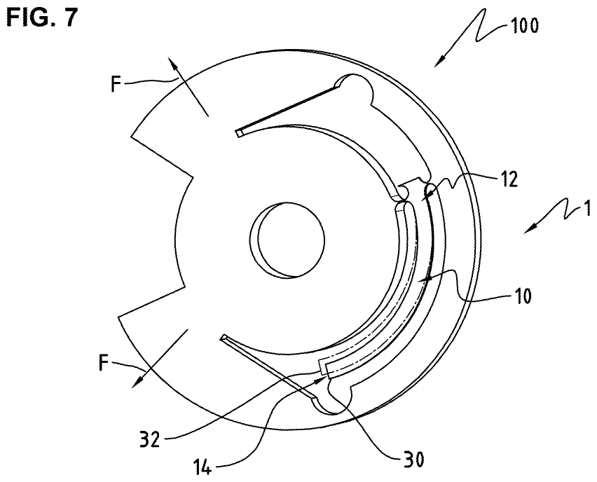

FIG. 7 shows a further embodiment of the sensor arrangement 1 for a specific application, which once again illustrates how universally the method according to the invention can be used. In the example shown, the component 100, which can be designated as a measuring body, is a washer, which is formed with an at least partially annular recess 110, in which the reference element 10 is fixed with its first end 12. The free length 13 of the reference element 10 runs largely arcuately within the recess 110 and ends in the second free end 14 with the edge 15 or a structure 17. The load can be a compressive force acting on the washer 100, whereby the washer undergoes a minimal elongation in the radial direction, as indicated by the arrows F. The sensor unit 20 (not shown) is positioned in such a way that a change in position of the second end 14 of the reference element 10 generated by the load on the washer 100 can be detected by the sensor unit 20. A difference value 33 between the reference value 30 in the unloaded state of the component 100 and the measured value 32 under load represents an initial value for determining the load, in this case a compressive load of the component 100 formed as a washer. In particular, however, the reference element 10 can also be regarded as a kind of measuring indicator whose changing position can be detected, and the determined values can be evaluated in the sense of the method in order to verify the acting load.

As can be seen from this and other examples, the dimensions of the sensor arrangement can be adapted to the circumstances, whereby both miniaturized and correspondingly large-dimensioned forms of the sensor arrangement 1 and/or the component 100 are conceivable.

In conclusion, it should be pointed out once again that the exemplary embodiments described here represent only realization possibilities of the ideas according to the invention and should in no way be regarded as limiting. The person skilled in the art will understand that other implementations of the invention and further elements are possible without neglecting the essential features of the invention.

1. Method for ascertaining a force and/or torque acting on a component in a mechanical system by means of a reference element clampable on the component by a first end, wherein a geometry and/or relative position of the reference element to the component is sensed by a sensor unit, and an effective force and/or torque is/are determined using an evaluation.

2. Method according to claim 1, wherein the geometry and/or the relative position can be determined by means of an edge, a surface and/or structure of the reference element.

3. Method according to claim 1, wherein the sensed geometry and/or relative positions define a reference value and a measured value, and a change in the force and/or torque acting on the component can be determined from a difference between the reference value and the measured value.

4. Method according to claim 3, wherein the difference is a path length and/or an angle.

5. Method according to claim 1, wherein the acting force and/or the torque is determinable based on a mathematical model which describes the acting force and/or the torque as a function of detected values and features of the component.

6. Method according to claim 1, wherein the acting force and/or torque can be determined based on a previous calibration.

7. Method according to claim 1, wherein the sensor unit detects the geometry and/or the relative position of the reference element inductively, magnetically, capacitively or optically.

8. Sensor arrangement for determining force and/or torque acting on a component in a mechanical system by means of the method according to claim 1, wherein the sensor arrangement comprises:
said reference element having a first end, which is-fixable, and a free length extending to a second end; and
said sensor unit disposable relative to the reference element and arranged to determine the geometry and/or the relative position of the reference element to the component.

9. Sensor arrangement according to claim 8, wherein the sensor arrangement is disposable on the component, the reference element being fixable to the component by the first end, the free length extending substantially parallel to a surface of the component and the sensor unit being disposable on the component to determine the geometry and/or the relative position of the reference element.

10. Sensor arrangement according to claim 8, wherein the second end of the reference element is a free end at which an edge, a surface and/or structure is formed, which is detectable by the sensor unit.

11. Sensor arrangement according to claim 8, wherein the second end of the reference element is fixable to the component and the sensor unit is arranged to detect a change in position and/or geometry of the reference element relative to the component.

12. Sensor arrangement according to claim 8, wherein the reference element is made in a material having a coefficient of thermal expansion corresponding to that of the component.

13. Sensor arrangement according to claim 8, wherein the sensor unit is an inductive sensor, a magnetic sensor, a capacitive sensor or an optical sensor.

14. Use of a sensor arrangement according to claim 8, wherein the component is a longitudinal component and the sensor arrangement is adapted to be arranged on the longitudinal component to determine an axial load of the component.

15. Use of a sensor arrangement according to claim 8, wherein the component is a longitudinal component and the sensor arrangement is adapted to be arranged on the longitudinal component borne on one side or both sides, in order to determine a loading by forces substantially transverse to a longitudinal axis of the longitudinal component.

16. Use of a sensor arrangement according to claim 8, wherein the component is a longitudinal component formed as a shaft and the sensor arrangement is configured to be arranged on the longitudinal component in order to determine a torsional load of the component.

17. Use of a sensor arrangement according to claim 8, wherein the sensor arrangement is adapted to be arranged in a region of a mechanical system which is in operative connection with the component in order to determine the load on the component.

18. Use of a sensor arrangement according to claim 8, wherein the component is a pipe or a container that can be acted upon by fluid and the sensor arrangement is adapted to be arranged on the component in order to determine a pressure load on the pipe or the container.
